(19) United States
(12) Patent Application Publication
(10) Pub. No.: US 2020/0293490 A1
(43) Pub. Date: Sep. 17, 2020

(54) FILE STORING METHOD, TERMINAL, AND COMPUTER-READABLE STORAGE MEDIUM

(71) Applicant: Ping An Technology (Shenzhen) Co., Ltd., Shenzhen, Guangdong (CN)

(72) Inventor: Zhoucheng Yi, Shenzhen, Guangdong (CN)

(21) Appl. No.: 16/318,696

(22) PCT Filed: Sep. 26, 2017
(86) PCT No.: PCT/CN2017/103545

§ 371 Date: Jan. 17, 2019

(30) Foreign Application Priority Data
Jul. 27, 2017 (CN) 201710622747.4

(51) Int. Cl. G06F 16/13; G06F 16/11; G06F 16/16; G06F 16/14

(52) U.S. Cl. CPC G06F 16/137; G06F 16/144; G06F 16/164; G06F 16/122

(57) ABSTRACT

The present disclosure discloses a file storing method which comprises: when a file storing instruction being received, determining a file name corresponding to the file to be stored; performing feature calculation on the determined file name to obtain a feature value; performing modulo operation to the feature value using the total number of file directories to obtain a modulus value, wherein the modulo operating is carried out by dividing the total number of the file directories by the feature value; determining a serial number corresponding to the file name based on the modulus value; and based on a mapping relationship between a preset serial number and a directory, determining the directory corresponding to the serial number, and storing the file in the determined directory. The present disclosure further discloses a terminal and a computer-readable storage medium. The flexibility of file storing is improved and the use of the directories is more balanced.

This application claims priority to Chinese Patent Application No. 201710622747.4, filed with the Chinese Patent Office on Jul. 27, 2017 and entitled “File Storing Method, Terminal, and Computer-readable Storage Medium”, which is incorporated herein by reference in its entirety.

### FIELD

The present disclosure relates to the field of file storing, and more particularly to a file storing method, terminal, and computer-readable storage medium.

### BACKGROUND

In current, with regards to file storing, the file is commonly first stored in a single directory, and when the files stored in the directory reaching a upper limit, make a backup of the files and then the directory is emptied for a continued file storing, or a new directory is added in the system for a continued file storing.

This file storing method requires assigning a certain directory for file storing in advance, and also needs to remember which files are stored in that directory in order to read the file later. Obviously, this file storing method is relatively rigid. Moreover, in a period of time that a plurality of files are stored in a same directory and the other remaining un-stored, will result in the directories storing files disproportionately.

### SUMMARY OF THE DISCLOSURE

The present disclosure is to provide a file storing method, terminal, and computer-readable storage medium, which aims to solve the technical problems of the existing file storing method being relatively rigid, and being prone to cause the directory storing files disproportionately.

In order to achieve the above aim, the present disclosure provides a file storing method, the file storing method includes:

when a file storing instruction being received, determining a file name corresponding to the file to be stored;

performing feature calculation on the determined file name to obtain a feature value;

performing modulo operation to the feature value using the total number of file directories to obtain a modulus value, wherein the modulo operating is carried out by dividing the total number of the file directories by the feature value;

determining a serial number corresponding to the file name based on the modulus value; and

based on a mapping relationship between a preset serial number and a directory, determining the directory corresponding to the serial number, and storing the file in the determined directory.

Furthermore, in order to achieve the above aim, the present disclosure provides a terminal for file storing, the terminal includes a memory, a processor, and a file storing program stored in the memory and operable on the processor, the file storing program being executed by the processor to perform the operations of the above file storing method.

Furthermore, in order to achieve the above aim, the present disclosure provides a computer-readable storage medium, the computer-readable storage medium stores a file storing program, which when executed by a processor performs the operations of the above file storing method.

In the technical solution provided by the present disclosure, when the file storing instruction is received, first the file name corresponding to the file to be stored is determined, afterwards feature calculation on the determined file name is performed to obtain the feature value, then perform modulo operation to the feature value using the total number of file directories to obtain the modulus value, the serial number corresponding to the file name based on the modulus value is determined, after that based on the mapping relationship between a preset serial number and a directory, the directory corresponding to the serial number is determined, in the end store the file in the determined directory. In the present disclosure, since the file names are various, the serial numbers corresponding to the file names are different; finally, the files can be stored in the corresponding directories according to the serial numbers corresponding to the file names. Since the storing directory is not required to be assigned, the file storing method is relatively flexible. In addition, it achieves to store the file in corresponding directory according to the serial number corresponding to the file name, instead of storing all the files in the same directory, so that the use of each directory is more balanced.

### BRIEF DESCRIPTION OF THE DRAWINGS

FIG. 1 is a structural diagram illustrating a terminal in a hardware operating environment involved in an embodiment according to the present disclosure.

FIG. 2 is a flowchart illustrating a first embodiment of the file storing method according to the present disclosure.

FIG. 3 is a first detailed flowchart illustrating S20 in FIG. 2 according to the present disclosure.

FIG. 4 is a second detailed flowchart illustrating S20 in FIG. 2 according to the present disclosure.

FIG. 5 is a flowchart illustrating a second embodiment of the file storing method according to the present disclosure.

FIG. 6 is a detailed flowchart illustrating S60 in FIG. 5 according to the present disclosure.

Various implementations, functional features, and advantages of the present disclosure will now be described in further detail with reference to the accompanying drawings and some illustrative embodiments.

### DETAILED DESCRIPTION OF THE EMBODIMENTS

It is to be understood that, the specific embodiments described herein portrays merely some illustrative embodiments of the present disclosure, and are not intended to limit the patentable scope of the present disclosure.

The solution of the embodiment of the present disclosure mainly is: when the file storing instruction is received, first the file name corresponding to the file to be stored is determined, afterwards feature calculation on the determined file name is performed to obtain the feature value, then perform modulo operation to the feature value using the total number of file directories to obtain the modulus value, the serial number corresponding to the file name based on the modulus value is determined, after that based on the mapping relationship between a preset serial number and a directory, the directory corresponding to the serial number is determined, in the end store the file in the determined directory. The problems of poor flexibility and being prone to cause the directory storing files disproportionately in the prior art are solved.

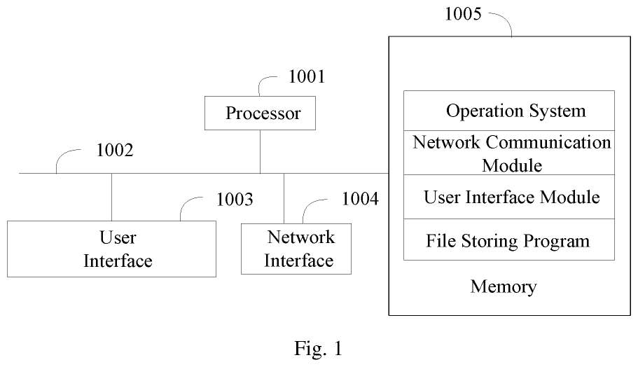

Referring to FIG. 1, FIG. 1 is a structural diagram illustrating a terminal in a hardware operating environment involved in an embodiment according to the present disclosure.

The device in the embodiment of the present disclosure may be a PC, or may be a mobile terminal device with a display function, such as a smart phone, a tablet computer, an e-book reader, or a portable computer.

As shown in FIG. 1, the device may include: a processor 1001, such as a CPU, a communication bus 1002, a user interface 1003, a network interface 1004, and a memory 1005. Among them, the communication bus 1002 is used to implement connection communication between these components. The user interface 1003 may include a display, an input unit such as a keyboard, the user interface 1003 may optionally further include a standard wired interface and a wireless interface. The network interface 1004 may optionally include a standard wired interface, a wireless interface (such as a WI-FI interface). The memory 1005 may be a high-speed RAM memory or a non-volatile memory such as a disk memory. Optionally the memory 1005 may be a storage device that is separate from the said processor 1001.

Optionally, the device may also include a camera, an RF (Radio Frequency) circuit, a sensor, an audio circuit, a WiFi module, and the like.

Those skilled in the art could understand that the terminal structure shown in FIG. 1 does not constitute a limitation on the terminal, and may include more or less components than the illustration, or combine some components, or different component arrangements.

As shown in FIG. 1, the memory 1005 as a computer-readable storage medium may include an operating system, a network communication module, a user interface module, and a file storing program. Among them, the operating system is a program for managing and controlling the terminal and software resources, and supports the operation of the network communication module, the user interface module, the file storing program, and other programs or software; the network communication module is used to manage and control the network interface 1002; and the user interface module is used to manage and control the user interface 1003.

In the terminal shown in FIG. 1, the network interface 1004 is mainly used to connect a server or an external device to perform data communication with the server or the external device; the user interface 1003 is mainly used to connect a terminal interface; the terminal invokes the file storing program stored in the memory 1005 through the processor 1001, to execute the operations below:

When a file storing instruction being received, determining the file name corresponding to a file to be stored;

Performing feature calculation on the determined file name to obtain a feature value;

Performing modulo operation to the feature value using the total number of file directories to obtain a modulus value, wherein the modulo operating is carried out by dividing the total number of the file directories by the feature value;

Determining a serial number corresponding to the file name based on the modulus value; and

Based on a mapping relationship between a preset serial number and a directory, determining the directory corresponding to the serial number, and storing the file in the determined directory.

Further, the step of the said terminal invoking the file storing program stored in the memory 1005 through the processor 1001, to perform feature calculation on the determined file name to obtain the feature value includes:

Based on a pre-stored binary lookup table, querying for a binary value corresponding to the file name;

Mapping the binary value to a fixed-length binary value by a preset hash function, using the fixed-length binary value as the feature value.

Further, the step of the said terminal invoking the file storing program stored in the memory 1005 through the processor 1001, to perform feature calculation on the determined file name to obtain the feature value includes:

Obtaining a pre-stored code table;

Based on the correspondence between the file name and an encoded value in the pre-stored code table, obtaining the encoded value corresponding to the file name, using the obtained encoded value as the feature value.

Further, subsequent to the step of based on mapping relationship between a preset serial number and a directory, determining the directory corresponding to the serial number, and storing the file in the determined directory, the terminal invokes the file storing program stored in the memory 1005 through the processor 1001, to execute the operations below:

When a file reading instruction being received, determining the directory where the file to be read is located based on the file name in the file reading instruction; and

Reading the file in the determined directory.

Further, the step of the terminal invokes the file storing program stored in the memory 1005 through the processor 1001, to execute when a file reading instruction being received, determining the directory where the file to be read is located based on the file name in the file reading instruction includes:

Determining the file name in the file reading instruction;

Performing feature calculation on the file name to obtain the feature value;

Based on the total number of file directories, performing modulo operation to the feature value corresponding to the file name, so as to determine the directory where the file to be read is located.

Further, subsequent to the step of when a file reading instruction being received, determining the directory where the file to be read is located based on the file name in the file reading instruction, the terminal invokes the file storing program stored in the memory 1005 through the processor 1001, to execute the operations below:

When the file cannot be read in the determined directory, querying for the total number of directories before change;

Based on the total number of directories before change, performing modulo operation to the feature value corresponding to the file name of the file to be read, so as to obtain a file directory;

Reading the file in the file directory.

Further, the terminal invokes the file storing program stored in the memory 1005 through the processor 1001, to execute the operations below:

When detecting that the storage capacity of the directory reaches the preset capacity value, if an adding instruction of the directory is received, determining the number of directories to be added;

Adding the determined number of directories in the system.

Further, the terminal invokes the file storing program stored in the memory 1005 through the processor 1001, to execute the operations below:

When detecting that the storage capacity of the directory reaches the preset capacity value, if a directory clear instruction is received, making a backup of the files in the directory to a preset storage area; and

Emptying the directory after completing the backup of the files.

In the technical solution provided by the present disclosure, when the file storing instruction is received, first the file name corresponding to the file to be stored is determined, afterwards feature calculation on the determined file name is performed to obtain the feature value, then perform modulo operation to the feature value using the total number of file directories to obtain the modulus value, the serial number corresponding to the file name based on the modulus value is determined, after that based on the mapping relationship between a preset serial number and a directory, the directory corresponding to the serial number is determined, in the end store the file in the determined directory. In the present disclosure, since the file names are various, the serial numbers corresponding to the file names are different; finally, the files can be stored in the corresponding directories according to the serial numbers corresponding to the file names. Since the storage directory is not required to be assigned, the file storage method is relatively flexible. In addition, it achieves to store the file in corresponding directory according to the serial number corresponding to the file name, instead of storing all the files in the same directory, so that the use of each directory is more balanced.

Based on the foregoing terminal hardware structure, various embodiments of the file storing method of the present disclosure are provided.

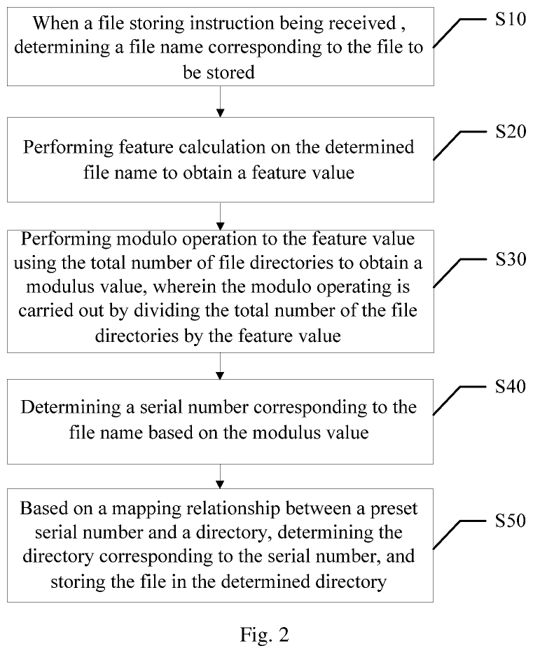

Referring to FIG. 2, FIG. 2 is a flowchart illustrating a first embodiment of the file storing method according to the present disclosure.

In the embodiment, the file storing method includes:

S10, when a file storing instruction being received, determining a file name corresponding to the file to be stored;

S20, performing feature calculation on the determined file name to obtain a feature value;

S30, performing modulo operation to the feature value using the total number of file directories to obtain a modulus value, wherein the modulo operating is carried out by dividing the total number of the file directories by the feature value;

S40, determining a serial number corresponding to the file name based on the modulus value;

S50, based on a mapping relationship between a preset serial number and a directory, determining the directory corresponding to the serial number, and storing the file in the determined directory.

In the embodiment, the file storing method is applied to the terminal which is illustrated in FIG. 1. The terminal is provided with one or more directories for storing files.

The following are the specific operations for implementing file storing in this embodiment:

S10, when a file storing instruction being received, determining a file name corresponding to the file to be stored, wherein, the file name includes Chinese characters, letters or numbers;

In the embodiment, the method of receiving the file storing instruction includes:

a. When the file imported by the external device is received by the terminal, the selection screen is displayed, receiving the file storing instruction triggered by the user on the selection screen.

b. When the file transmitted by the server is received by the terminal, the selection screen is displayed, receiving the file storing instruction triggered by the user on the selection screen.

c. The terminal receiving the file storing instruction triggered when the local data information generating the file.

When the file storing instruction is received, first the file to be stored corresponding to the file storing instruction is determined It is certain that when the file storing instruction is triggered, it is triggered for a specific file, therefore the corresponding file to be stored could be determined according to the file storing instruction.

After the file to be stored instruction is determined, the file name of the file to be stored is identified. In the embodiment, the file name includes but is not limited to a Chinese character, a letter, a numeral, a symbol, or a combination of any two or more of the above.

It should be noted that the file name of the file to be stored in this embodiment may be the name came with the file before the terminal receives the file. That is, before the external device imports the file to the terminal, or before the server transfers the file to the terminal, the file has been added with the file name. After the subsequent terminal receives the file, the file name corresponding to the file can be directly identified.

In addition, in the embodiment of the present disclosure, when the terminal receives the file or the local generated file, the file name may be regenerated for each file according to a preset rule. The preset rule may be set as: add a file name to the file according to a letter, and the added file name is added in alphabetical order, for example, first add the letter a to the first file, then add the letter b to the second file, and so on, add the corresponding letter for each file to implement adding the file name. After adding the file name to the file, the file name for each file can be determined

It should be understood that the foregoing pre-set rules are merely exemplary, and other rules proposed by those skilled in the art according to the technical idea of the present disclosure are within the scope of the present disclosure, and will not be further described herein.

In this embodiment, in order to facilitate the management of file storing, preferably, when the terminal receives the file, regenerate the corresponding file name according to the preset rule provided by the terminal system, and then the serial number for each file could be determined quickly according to the file name, so as to store the file quickly, instead of dealing with file names respectively with different types to obtain the serial numbers, the present disclosure can be processed in the same manner, which improves the efficiency of file storing.

S20, performing feature calculation on the determined file name to obtain a feature value;

In the embodiment, the implementation methods of S20 include:

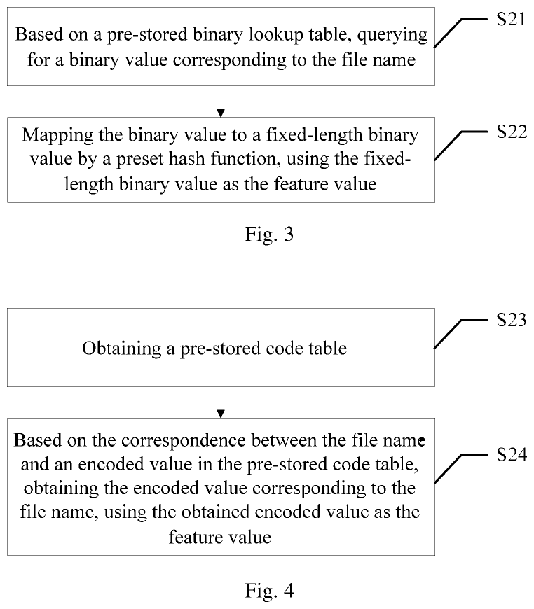

1) Method 1, referring to FIG. 3, S20 includes:

S21, based on a pre-stored binary lookup table, querying for a binary value corresponding to the file name;

S22, mapping the binary value to a fixed-length binary value by a preset hash function, using the fixed-length binary value as the feature value.

In the embodiment, after the file name corresponding to the file is determined, consult the preset binary lookup table, such as an ASCII table, to determine the binary value corresponding to the file name. In the embodiment, the ASCII table stores the correspondence between Chinese characters, letters or numbers with binary values.

It should be noted that the length of each binary value is not fixed, because the file names of different files are different, the length of each binary value obtained by looking up the table may be different.

After determining the binary value of each file, perform hash calculation on the binary value of each file name, the hash calculation is carried out: by mapping the binary value with arbitrary length to a smaller binary value with a fixed length via the hash function. For example, if the binary value of the file name is 11050201, then after mapping by the hash function, 778 is obtained, and this smaller binary value is called a hash value. In this way, the hash calculation on the file name can be implemented, and the hash function is set according to the actual situation, which is not limited herein.

2) Method 2, referring to FIG. 4, S20 includes:

S23, obtaining a pre-stored code table;

S24, based on the correspondence between the file name and an encoded value in the pre-stored code table, obtaining the encoded value corresponding to the file name, using the obtained encoded value as the feature value.

In the embodiment, after determining the file name corresponding to the file, it could perform code mapping to the file name. Specifically, first the preset code table is consulted to determine the encoded value corresponding to the file name according to the code table. It should be noted that the code table is a pre-established table, and includes correspondences between various letters, Chinese characters, numbers, or symbols with the encoded values. Therefore, after the file name is identified, the encoded value can be determined by looking up the code table. For example, the file name of the file is the letter T. By looking up the code table, the corresponding encoded value is 6.

After obtaining the corresponding hash value or the encoded value according to the file name, the hash value and the encoded value are equivalent to the feature value, later it could perform a modulo operation to the hash value and the encoded value to obtain the corresponding modulus value.

S30, performing modulo operation to the feature value using the total number of file directories to obtain a modulus value, wherein the modulo operating is carried out by dividing the total number of the file directories by the feature value;

In the embodiment, before modulo operation to the feature value, first determine the total number of current file directories in the terminal, and then modulo the feature value of the file name according to the total number of file directories to obtain the modulus value, specifically, the total number of file directories is divided by the feature value. Since the feature value includes the hash value and the encoded value, dividing the total number of file directories by the feature value is equivalent to dividing the total number of file directories by the hash value or the encoded value of the file name. After dividing the total number of file directories by the hash value or the encoded value, using the obtained remainder as the modulus of the file name.

For a better understanding, examples are as follows:

The current total number of file directories is 7. If the hash value or the encoded value of the file is 2, then the total number of file directories 7 is divided by 2, and the remainder is 1, the modulus value of the file name is 1; if the hash value of the current file is 4, the total number of file directories 7 is divided by 4, and the remainder is 3, the modulus value of the file name is 3.

S40, determining a serial number corresponding to the file name based on the modulus value.

After calculating the modulus value of the file name, the serial number corresponding to the file name based on the modulus value is determined. For example, the modulus value after the feature calculation is 1, then the serial number corresponding to the file name is 1, if the modulus value after the feature calculation is 3, the serial number corresponding to the file name is 3.

S50, based on a mapping relationship between a preset serial number and a directory, determining the directory corresponding to the serial number, and storing the file in the determined directory.

After determining the serial number corresponding to each file name, the mapping relationship between the serial number and the directory is further determined In the embodiment, preferably the mapping relationship is a one-to-one relationship, that is, one serial number corresponds to one directory, and therefore, after the serial number corresponding to the file name is determined, the directory for storing the file can be determined, and finally the file is stored in the determined directory.

In the technical solution provided by the present disclosure, when the file storing instruction is received, first the file name corresponding to the file to be stored is determined, afterwards feature calculation on the determined file name is performed to obtain the feature value, then perform modulo operation to the feature value using the total number of file directories to obtain the modulus value, the serial number corresponding to the file name based on the modulus value is determined, after that based on the mapping relationship between a preset serial number and a directory, the directory corresponding to the serial number is determined, in the end store the file in the determined directory. In the present disclosure, since the file names are various, the serial numbers corresponding to the file names are different; finally, the files can be stored in the corresponding directories according to the serial numbers corresponding to the file names. Since the storage directory is not required to be assigned, the file storing method is relatively flexible. In addition, it achieves to store the file in corresponding directory according to the serial number corresponding to the file name, instead of storing all the files in the same directory, so that the use of each directory is more balanced.

Further, a second embodiment of the file storing method of the present disclosure is provided based on the first embodiment.

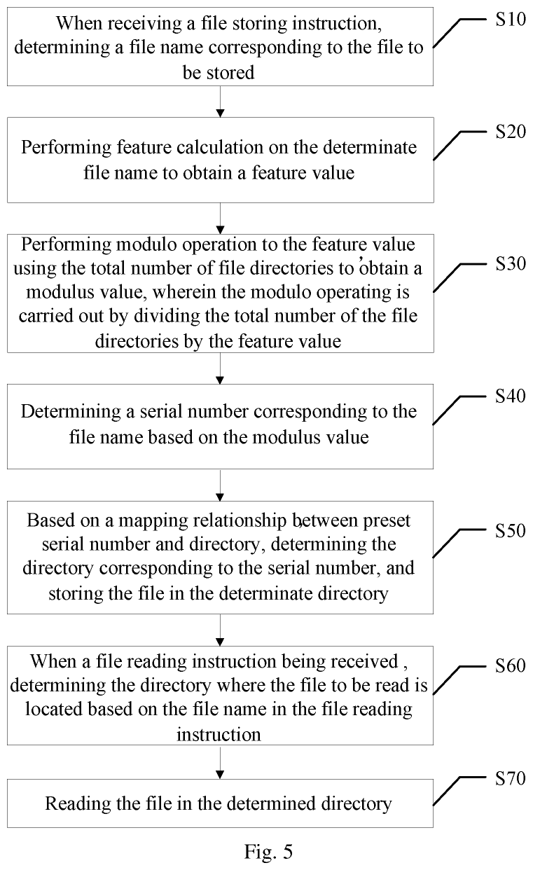

The difference between the second embodiment of the file storing method and the first embodiment of the file storing method is that, referring to FIG. 5, after S50, the method further includes:

S60, when a file reading instruction being received, determining the directory where the file to be read is located based on the file name in the file reading instruction; and

S70, reading the file in the determined directory.

In the embodiment, the methods of receiving the file reading instruction include:

d. The file reading instruction triggered by the user input the file name is received by the terminal on the preset search screen;

e. The file reading instruction triggered by the user voice input the file name is received by the terminal.

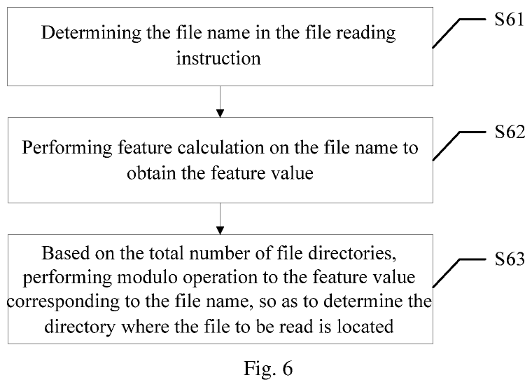

When the file reading instruction is received, the terminal determines the directory where the file to be read is located based on the file name in the file reading instruction. Specifically, referring to FIG. 6, S60 includes:

S61, determining the file name in the file reading instruction;

S62, performing feature calculation on the file name to obtain the feature value;

S63, based on the total number of file directories, performing modulo operation to the feature value corresponding to the file name, so as to determine the directory where the file to be read is located.

That is, when the file read instruction is received by the terminal, the file name to be read based on the file read instruction is determined, and then using the total number of file directories modulo the file name to obtain the directory in which the determined file to be read is located. Specifically, first feature calculation on the file name is performed to obtain the feature value, then use the total number of file directories modulo the feature value to obtain the modulus number, the modulus number is the serial number corresponding to the file name, at last the directory where the file to be read is located is determined based on the serial number. The specific processing method is already described in the foregoing embodiment, and details will not be described herein again.

In the embodiment, the directory of the file is also obtained based on modulo operation of the feature value, so that the file can be obtained in the correct directory, and it is not necessary to memorize which file exists in which directory, and is transparent to the upper application, the convenience and intelligence of file storing are improved.

Further, a third embodiment of the file storing method of the present disclosure is provided based on the second embodiment.

The difference between the third embodiment of the file storing method and the second embodiment of the file storing method is that, after S60, the method further includes:

Step A, when the file cannot be read in the determined directory, querying for the total number of directories before change;

Step B, based on the total number of directories before change, performing modulo operation to the feature value corresponding to the file name of the file to be read, so as to obtain a file directory;

Step C, reading the file in said file directory.

In the embodiment, after the file name is processed through the above processing, and the directory where the file is located is obtained, if the file corresponding to the file name cannot be read in the directory, it means the file name is not stored in the directory, and the number of directories in the terminal has been changed. That is, when the file was stored before, the serial number of the file name was determined by the total number of directories before the change. Therefore, the directory is the one corresponding to the previous serial number. Now the serial number of the file name is determined by the changed total number of the directories. So the calculated directory is different from the previous one, the stored file cannot be found. The change of the directories includes: increasing the number of the directories or reducing the number of the directories.

Therefore, in the embodiment, when the file cannot be read in the determined directory, the terminal queries for the total number of the directories before the change from the backup document, that is, the terminal saves the specific number of the file directories, and even if it changes, the terminal still could perform the querying, after querying for the total number of directories before the change, and then modulo the file name of the file to be read based on the total number of the directories before the change to obtain the file directory, and finally read the file in the file directory. The specific processing method is described in detail in the above embodiment, and details will not be described herein again.

In the embodiment, when reading the file, as the number of the directories is changed, it could use the corresponding number of the directories to determine the directory where the file is located, and the upper layer application does not need to modify the file name, thereby the convenience and intelligence of file storing are improved.

Further, a forth embodiment of the file storing method of the present disclosure is provided based on the first, second and third embodiments.

The difference between the forth embodiment of the file storing method and the first, second and third embodiments of the file storing method is the method further includes:

Step D, when detecting that the storage capacity of the directory reaches the preset capacity value, if an adding instruction of the directory is received, determining the number of directories to be added;

Step E, adding the determined number of directories in the system.

In the embodiment, the file directory in the terminal may be one or more, and it is not limited, and it is set according to actual situation.

When the terminal detects that the storage capacity of the existing directory reaches the preset capacity value, the terminal may output a prompt message to indicate that the directory is overloaded. At this moment, if the adding instruction of the directory is received, a selection screen is displayed for the user to input the number of the directory to be added, and finally the directory corresponding to the number is added in the terminal, and the preset capacity value and the number of the directory to be added are not limited.

After adding the new directory, the newly added directory is sorted based on the existing directory, and the mapping relationship table corresponding to the serial number and the directory is updated to add the serial number corresponding to the newly added directory in the relationship mapping table. After the new directory is added, the total number of directories in the terminal is also changed accordingly, so that the storing and reading of the file are more accurate when performing the subsequent feature processing.

In addition, the method further includes:

Step F, when detecting that the storage capacity of the directory reaches the preset capacity value, if a directory clear instruction is received, making a backup of the files in the directory to a preset storage area; and

Step G, emptying the directory after completing the backup of the files.

That is, when it is detected that the storage capacity of the directory reaches the preset capacity value, if a directory clear instruction is received, at this moment, the existing file in the directory is directly backed up to the preset storage area without adding a new directory. Then the directory is emptied so that subsequently the file could continue to be stored according to the directory.

In the embodiment, when the file storage capacity of the directory reaches the preset capacity value, perform the processing through the foregoing two methods, so as to continue to store the file subsequently, thereby the flexibility of file storage is improved.

In addition, the present disclosure further provides a computer-readable storage medium, the computer-readable storage medium stores a file storing program, which when executed by a processor performs the operations below:

When a file storing instruction being received, determining a file name corresponding to the file to be stored;

Performing feature calculation on the determined file name to obtain a feature value;

Performing modulo operation to the feature value using the total number of file directories to obtain a modulus value, wherein the modulo operating is carried out by dividing the total number of the file directories by the feature value;

Determining a serial number corresponding to the file name based on the modulus value; and

Based on a mapping relationship between a preset serial number and a directory, determining the directory corresponding to the serial number, and storing the file in the determined directory.

Further, when the file storing program is executed by the processor, the operation of performing feature calculation on the determined file name to obtain the feature value is also implemented:

Based on a pre-stored binary lookup table, querying for a binary value corresponding to the file name;

Mapping the binary value to a fixed-length binary value by a preset hash function, using the fixed-length binary value as the feature value.

Further, when the file storing program is executed by the processor, the operation of performing feature calculation on the determined file name to obtain the feature value is also implemented:

Obtaining a pre-stored code table;

Based on the correspondence between the file name and an encoded value in the pre-stored code table, obtaining the encoded value corresponding to the file name, using the obtained encoded value as the feature value.

Further, subsequent to the step of based on mapping relationship between a preset serial number and a directory, determining the directory corresponding to the serial number, and storing the file in the determined directory, when the file storing program is executed by the processor, the following operations are implemented:

When a file reading instruction being received, determining the directory where the file to be read is located based on the file name in the file reading instruction; and

Reading the file in the determined directory.

Further, when the file storing program is executed by the processor, the operation of when a file reading instruction being received, determining the directory where the file to be read is located based on the file name in the file reading instruction is also implemented:

Determining the file name in the file reading instruction;

Performing feature calculation on the file name to obtain the feature value;

Based on the total number of file directories, performing modulo operation to the feature value corresponding to the file name, so as to determine the directory where the file to be read is located.

Further, subsequent to the step of when a file reading instruction being received, determining the directory where the file to be read is located based on the file name in the file reading instruction, when the file storing program is executed by the processor, the following operations are implemented:

When the file cannot be read in the determined directory, querying for the total number of directories before change;

Based on the total number of directories before change, performing modulo operation to the feature value corresponding to the file name of the file to be read, so as to obtain a file directory;

Reading the file in the file directory.

Further, when the file storing program is executed by the processor, the following operations are implemented:

When detecting that the storage capacity of the directory reaches the preset capacity value, if an adding instruction of the directory is received, determining the number of directories to be added;

Adding the determined number of directories in the system.

Further, when the file storing program is executed by the processor, the following operations are implemented:

When detecting that the storage capacity of the directory reaches the preset capacity value, if a directory clear instruction is received, making a backup of the files in the directory to a preset storage area;

Emptying the directory after completing the backup of the files.

In the technical solution provided by the present disclosure, when the file storing instruction is received, first the file name corresponding to the file to be stored is determined, afterwards feature calculation on the determined file name is performed to obtain the feature value, then perform modulo operation to the feature value using the total number of file directories to obtain the modulus value, the serial number corresponding to the file name based on the modulus value is determined, after that based on the mapping relationship between a preset serial number and a directory, the directory corresponding to the serial number is determined, in the end store the file in the determined directory. In the present disclosure, since the file names are various, the serial numbers corresponding to the file names are different; finally, the files can be stored in the corresponding directories according to the serial numbers corresponding to the file names. Since the storing directory is not required to be assigned, the file storing method is relatively flexible. In addition, it achieves to store the file in corresponding directory according to the serial number corresponding to the file name, instead of storing all the files in the same directory, so that the use of each directory is more balanced.

It should be noted that, throughout this disclosure, the terms “include”, “comprise” or any other variations thereof are intended to encompass non-exclusive inclusions, so that a process, method, article, or system that includes a series of elements would include not only those elements, but it may further include other elements that are not explicitly listed or elements that are inherent to such processes, methods, articles, or systems. In the absence of extra limitations, an element defined by the phrase “includes a . . . ” does not exclude the presence of additional identical elements in this process, method, article, or system that includes the element.

Sequence numbers of the embodiments disclosed herein are meant for the sole purpose of illustrative and do not represent the advantages and disadvantages of these embodiments.

Through the above description of the foregoing embodiments, those skilled in the art can clearly understand that the above methods of the embodiments can be implemented by means of software plus a necessary general hardware platform; they certainly can also be implemented by means of hardware, but in many cases, the former is a better implementation. Based on this understanding, the essential part of the technical solution according to the present disclosure or the part that contributes to the prior art can be embodied in the form of a software product. Computer software products can be stored in a storage medium as described above (e.g., ROM/RAM, a magnetic disk, an optical disc) which includes instructions to cause a terminal device (e.g., a mobile phone, a computer, a server, an air conditioner, or a network device, etc.) to perform the methods described in the various embodiments of the present disclosure.

The foregoing description portrays merely some illustrative embodiments of the present disclosure, and is not intended to limit the patentable scope of the present disclosure. Any equivalent structural or flow transformations based on the specification and the drawing of the present disclosure, or any direct or indirect applications of the present disclosure in other related technical fields, shall all fall within the protection scope of the present disclosure.

What is claimed is:

1. A file storing method, comprising:
when a file storing instruction being received, determining a file name corresponding to the file to be stored;
performing feature calculation on the determined file name to obtain a feature value;
performing modulo operation to the feature value using the total number of file directories to obtain a modulus value, wherein the modulo operating is carried out by dividing the total number of the file directories by the feature value;
determining a serial number corresponding to the file name based on the modulus value; and
based on a mapping relationship between a preset serial number and a directory, determining the directory corresponding to the serial number, and storing the file in the determined directory.

2. The method of claim 1, wherein the step of performing feature calculation on the determined file name to obtain a feature value comprises:
based on a pre-stored binary lookup table, querying for a binary value corresponding to the file name;
mapping the binary value to a fixed-length binary value by a preset hash function, using the fixed-length binary value as the feature value.

3. The method of claim 1, wherein the step of performing feature calculation on the determined file name to obtain a feature value further comprises:
obtaining a pre-stored code table;
based on the correspondence between the file name and an encoded value in the pre-stored code table, obtaining the encoded value corresponding to the file name, using the obtained encoded value as the feature value.

4. The method of claim 1, subsequent to the step of based on a mapping relationship between a preset serial number and a directory, determining the directory corresponding to the serial number, and storing the file in the determined directory, further comprising:
when a file reading instruction being received, determining the directory where the file to be read is located based on the file name in the file reading instruction; and
reading the file in the determined directory.

5. The method of claim 4, wherein the step of when a file reading instruction being received, determining the directory where the file to be read is located based on the file name in the file reading instruction comprises:
determining the file name in the file reading instruction;
performing feature calculation on the file name to obtain the feature value;
based on the total number of file directories, performing modulo operation to the feature value corresponding to the file name, so as to determine the directory where the file to be read is located.

6. The method of claim 4, subsequent to the step of when a file reading instruction being received, determining the directory where the file to be read is located based on the file name in the file reading instruction, further comprising:
when the file cannot be read in the determined directory, querying for the total number of directories before change;
based on the total number of directories before change, performing modulo operation to the feature value corresponding to the file name of the file to be read, so as to obtain a file directory;
reading the file in the file directory.

7. The method of claim 1, further comprising:
when detecting that the storage capacity of the directory reaches the preset capacity value, if an adding instruction of the directory is received, determining the number of directories to be added;
adding the determined number of directories in the system.

8. The method of claim 2, further comprising:
when detecting that the storage capacity of the directory reaches the preset capacity value, if an adding expansion instruction of the directory is received, determining the number of directories to be added;
adding the determined number of directories in the system.

9. The method of claim 3, further comprising:
when detecting that the storage capacity of the directory reaches the preset capacity value, if an adding expansion instruction of the directory is received, determining the number of directories to be added;
adding the determined number of directories in the system.

10. The method of claim 4, further comprising:
when detecting that the storage capacity of the directory reaches the preset capacity value, if an adding expansion instruction of the directory is received, determining the number of directories to be added;
adding the determined number of directories in the system.

11. The method of claim 5, further comprising:
when detecting that the storage capacity of the directory reaches the preset capacity value, if an adding expansion instruction of the directory is received, determining the number of directories to be added;
adding the determined number of directories in the system.

12. The method of claim 6, further comprising:
when detecting that the storage capacity of the directory reaches the preset capacity value, if an adding expansion instruction of the directory is received, determining the number of directories to be added;
adding the determined number of directories in the system.

13. The method of claim 1, further comprising:
when detecting that the storage capacity of the directory reaches the preset capacity value, if a directory clear instruction is received, making a backup of the files in the directory to a preset storage area; and
emptying the directory after completing the backup of the files.

14. The method of claim 2, further comprising:
when detecting that the storage capacity of the directory reaches the preset capacity value, if a directory clear instruction is received, making a backup of the files in the directory to a preset storage area; and
emptying the directory after completing the backup of the files.

15. The method of claim 3, further comprising:
when detecting that the storage capacity of the directory reaches the preset capacity value, if a directory clear instruction is received, making a backup of the files in the directory to a preset storage area; and
emptying the directory after completing the backup of the files.

16. The method of claim 4, further comprising:
when detecting that the storage capacity of the directory reaches the preset capacity value, if a directory clear instruction is received, making a backup of the files in the directory to a preset storage area; and
emptying the directory after completing the backup of the files.

17. The method of claim 5, further comprising:
when detecting that the storage capacity of the directory reaches the preset capacity value, if a directory clear instruction is received, making a backup of the files in the directory to a preset storage area; and
emptying the directory after completing the backup of the files.

18. The method of claim 6, further comprising:
when detecting that the storage capacity of the directory reaches the preset capacity value, if a directory clear instruction is received, making a backup of the files in the directory to a preset storage area; and
emptying the directory after completing the backup of the files.

19. A terminal, comprising:
a memory, a processor, and a file storing program stored in the memory and operable on the processor, the file storing program being executed by the processor to perform the operations of the file storing method according to claim 1.

20. A computer-readable storage medium storing a file storing program, which when executed by a processor performs the operations of the file storing method according to claim 1.
